(19) United States
(12) Patent Application Publication
(10) Pub. No.: US 2017/0325435 A1
(43) Pub. Date: Nov. 16, 2017

(54) RATTLING FISHING JIG

(71) Applicant: Frank Crescitelli, Staten Island, NY (US)

(72) Inventor: Frank Crescitelli, Staten Island, NY (US)

(21) Appl. No.: 15/663,012

(22) Filed: Jul. 28, 2017

Related U.S. Application Data
(63) Continuation-in-part of application No. 14/876,905, filed on Oct. 7, 2015.
Application No. 14/876,905 is a continuation of application No. 13/709,191, filed on Dec. 10, 2012, now abandoned.

(51) Int. Cl. A01K 85/01; A01K 85/00; A01K 85/16; A01K 91/04

(52) U.S. Cl. CPC A01K 85/01; A01K 91/04; A01K 85/00; A01K 85/16

(57) ABSTRACT

A rattling fishing jig includes a body including an outer envelope. A fishing line eyelet is disposed on an upper portion of the body. At least one noise-making capsule is disposed in the body. A hook shank includes a first hook. The hook shank is connected to the body. The hook shank is in direct contact with the noise-making capsule. A stinger attachment eyelet is disposed on a bottom portion of the body. A continuous wire is disposed in the body. A first end of the continuous wire is connected to the stinger attachment eyelet. A second end of the continuous wire opposite the first end is connected to the fishing line eyelet.

### CROSS-REFERENCE TO RELATED APPLICATION

This application is a continuation in part of U.S. patent application Ser. No. 14/876,905, filed on Oct. 7, 2015, which is a continuation of U.S. patent application Ser. No. 13/709,191, filed on Dec. 10, 2012, the disclosures of which are incorporated by reference herein in their entireties.

### TECHNICAL FIELD

Exemplary embodiments of the present invention relate to a fishing jig, and more importantly to a rattling fishing jig.

### BACKGROUND

The present invention is a rattling fishing jig to be used in fishing, and preferably fishing for saltwater, striped bass or freshwater, largemouth, smallmouth, or spotted bass. Striped bass, also known as stripers or rockfish, have a lifespan of up to thirty years. Adult striped bass can grow to be over one hundred pounds and up to six feet long. Striped bass are often found near rocky reefs and shipwrecks. It is known that large striped bass feed on lobsters and other invertebrates that are found hiding in or around rocky areas. Freshwater bass are known to feed on crayfish and other invertebrates that inhabit rocky areas of lakes or rivers.

Striped bass are lazy feeders that do not go out of their way to get food. They often eat fish and other food flowing by in the current or prey on animals that are close by. Unlike many other fish, striped bass do not actively seek prey.

Fishing for bass is very popular in sport fishing. When fishing for striped bass from a boat, fishermen often use a fishing rod and line with a weight, also known as a sinker, which falls to the water's bottom and a leader trailing behind the sinker that has a baited hook on the end. The leader and the baited hook flow with the current and presents food to the fish. Often the bait used is an eel. However, due to the nature of striped bass, they will strike at the bait only if it is presented directly to them. Since the exact location of the fish is unknowable, this behavior makes fishing for striped bass a hit or miss affair.

Although much freshwater bass fishing is done on the surface with so-called popper or spinner lures, fishermen sometimes use a deep water technique similar to fishing for striped bass when fishing for freshwater bass. The difference is in the size of the weight and hook (which are naturally much smaller than for striped bass) and the bait (which is often artificial). This freshwater fishing technique is sometimes called “drop shot”.

Conventional noise-making lures and weights have a linear noise-making device. In most designs, the outside diameters of the noise-making beads are approximately the same size as the inside diameter of the noise-making chamber. This linear type of noise-making device fails to accurately mimic an invertebrate prey because it does not produce a sound of multiple legs walking on the water's rocky bottom. Further, lures and weights that incorporate this linear device typically place the noise-making device on the jig-head, which subjects itself to easy breakage and snagging and impedes the ability to attach bait to the hook, or place a single noise-making chamber within the jig head, which muffles the rattle sound.

Other conventional noise-making lures and weights that incorporate multiple loose rattle members only create the rattling sound from a linear, one-direction motion. Such devices are designed to be fished using a technique of jigging or twisting, but cannot do both. Such designs also have complicated noise-making chambers that require internal sections of the lure to be hollow while still enabling the fishing line to pass-through the lure's body. These designs drastically increase the cost of manufacturing.

Currently, fishermen use conventional noise-making lures and weights that are designed and built to be used near the water's surface and in medium depth waters to fish off the water's bottom. These noise-making lures are designed and built to only attract the small, top-feeder fish and are difficult to use off the water's bottom because they lack the durability to withstand the continuous thrashing against a rocky bottom. Such lures and weights are also not successfully fished off the water's bottom because they do not produce an adequate sound that mimics an invertebrate prey that is walking on the bottom nor do they produce a multi-dimensional, complex sound that enables the lure to be jigged or twisted in the current. As a result, using a conventional noise-making lure or weight off the water's bottom does not attract the larger, bottom-feeder fish that are the most desirable to catch.

Traditional lures and weights not only lack the durability to be used to fish off the water's bottom, but they also lack versatility. A fisherman typically needs multiple different types of weights for different fishing techniques and then also needs an associated lure. As a result, a fisherman is forced into having to carry pounds of various lead sinker weights and multiple different types of tackle, rather than being able to dress a single sinker weight as a lure.

The introduction of lead into the human body is another issue facing the fishing industry. As it is commonly known, lead is a harmful heavy metal in which toxic levels can build up in the body over time. The most common ways of introducing lead into the body are ingestion and inhalation. Avid fishermen's repeated handling of lead weights and then touching their mouths or eating without washing their hands, or adjusting lead weights with their teeth, a common bad habit among many fishermen, can introduce lead into their systems.

Accordingly, it is desirable to have a combination fishing lure and weight that incorporates a multi-dimensional noise-making device that attracts fish, particularly striped bass and freshwater bass, by mimicking the sound of invertebrate prey walking on the water's rocky bottom. It is also desirable to have a fishing lure and weight that is versatile so that fishermen can carry less tackle, built to withstand the rough abuse of fishing off the water's rocky bottom, and has a protective coating covering the lead weight to protect fishermen from harmful lead exposure.

### SUMMARY

According to an exemplary embodiment of the present invention, a rattling fishing jig includes a body including an outer envelope. A fishing line eyelet is disposed on an upper portion of the body. At least one noise-making capsule is disposed in the body. A hook shank includes a first hook. The hook shank is connected to the body. The hook shank is in direct contact with the noise-making capsule. A stinger attachment eyelet is disposed on a bottom portion of the body. A continuous wire is disposed in the body. A first end of the continuous wire is connected to the stinger attachment eyelet. A second end of the continuous wire opposite the first end is connected to the fishing line eyelet.

According to an exemplary embodiment of the present invention, the hook shank may be directly connected to the continuous wire.

According to an exemplary embodiment of the present invention, the hook shank may be directly connected to the fishing line eyelet.

According to an exemplary embodiment of the present invention, the continuous wire may be a metal wire.

According to an exemplary embodiment of the present invention, the metal wire may include brass or stainless steel.

According to an exemplary embodiment of the present invention, the noise-making capsule may include two capsules.

According to an exemplary embodiment of the present invention, each of the two capsules may be in direct contact with the hook shank.

According to an exemplary embodiment of the present invention, the body may include a tail including animal or synthetic hair coupled to the body adjacent the hook shank.

According to an exemplary embodiment of the present invention, the continuous wire connecting the stinger attachment eyelet to the fishing line eyelet may have a length configured to create tension between the stinger attachment eyelet and the fishing line eyelet. The tension between the stinger attachment eyelet and the fishing line eyelet may be configured to transmit a force applied to the stinger attachment eyelet to a fishing line connected to the fishing line eyelet.

According to an exemplary embodiment of the present invention, the noise-making capsule may be in direct contact with the continuous wire.

According to an exemplary embodiment of the present invention, a rattling fishing jig includes a body including an outer envelope. A fishing line eyelet is coupled to the body. At least one noise-making capsule is disposed in the body. A hook shank includes a first hook. The hook shank is connected to the body. The hook shank is in direct contact with the noise-making capsule disposed in the body. A stinger attachment eyelet is coupled to the body. A continuous wire is disposed in the body. A first end of the continuous wire is connected to the stinger attachment eyelet. A second end of the continuous wire opposite the first end is connected to the fishing line eyelet. The continuous wire is in direct contact with the noise-making capsule disposed in the body.

### BRIEF DESCRIPTION OF THE DRAWINGS

The above and other features of the present invention will become more apparent by describing in detail exemplary embodiments thereof, with reference to the accompanying drawings in which:

FIG. 1 is a plan view of a bucktail fishing jig according to an exemplary embodiment of the present invention; and

FIG. 2 is a cross-sectional view of a bucktail fishing jig according to an exemplary embodiment of the present invention.

### DETAILED DESCRIPTION

It will be understood that the terms “first,” “second,” “third,” etc. are used herein to distinguish one element from another, and the elements are not limited by these terms. Thus, a “first” element in an exemplary embodiment may be described as a “second” element in another exemplary embodiment.

Exemplary embodiments of the present invention will be described more fully hereinafter with reference to the accompanying drawings. Like reference numerals may refer to like elements throughout the specification and drawings.

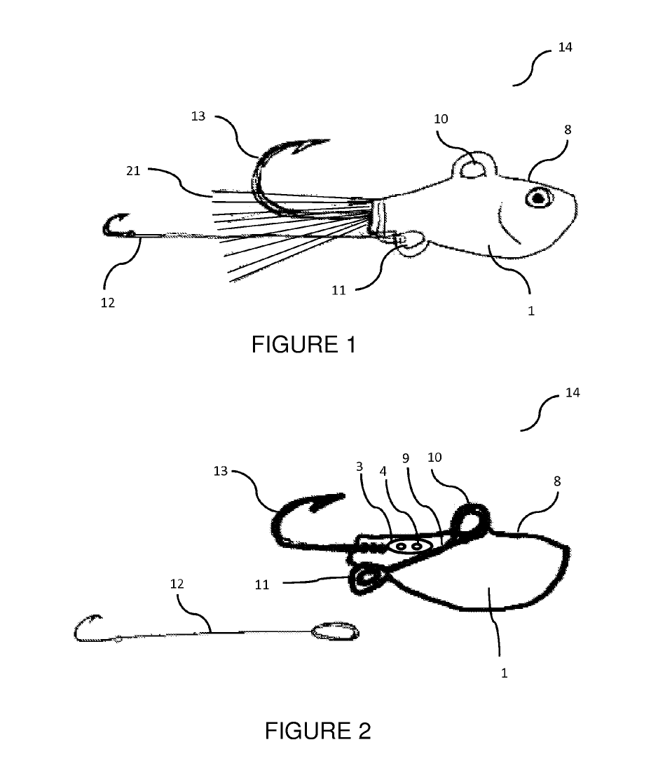

FIG. 1 is a plan view of a bucktail fishing jig according to an exemplary embodiment of the present invention. FIG. 2 is a cross-sectional view of a bucktail fishing jig according to an exemplary embodiment of the present invention.

Referring to FIGS. 1 and 2, according to an exemplary embodiment of the present invention, a fishing jig such as a rattling fishing jig (e.g., a bucktail fishing jig) includes one or more noise-making capsules 3 incorporated into a bucktail fishing lure 14. Referring to FIGS. 1 and 2, this bucktail fishing lure 14 includes a body 1, an outer envelope 8, a noise-making capsule 3 with beads 4, a continuous wire 9 with eyelet 10 and stinger hook attachment 11, and an optional stinger wire and hook 12. The body 1 also includes a tail 21 and hook shank 13. Within the body 1, the noise-making capsule 3 is attached to the hook shank 13 to transmit the rattling sound through the metal hook shank 13. In one embodiment, the bucktail fishing lure 14 incorporates a two capsule noise-making design to produce a multi-dimensional, complex sound.

In use, the fishing line from a fisherman's pole attaches to the eyelet 10, while the stinger hook attachment 11 enables a fisherman to attach the optional stinger wire and hook 12, which allows a fisherman to attach bait to the bucktail fishing lure 14 without affecting the lure's swimming abilities. The continuous wire 9, which incorporates the eyelet 10 and stinger hook attachment 11, allows the force from a fish strike to be carried directly to the fisherman's line. This eliminates the risk of having a fish pull an attaching eyelet out from the body 1 and increases the fisherman's line sensitivity. The line sensitivity is increased because the fish's striking force travels directly from the optional stinger wire and hook 12, through the continuous wire 9, and directly to the fishing line rather than travelling through the body 1. In another embodiment, the hook shank 13 is also connected to the continuous wire 9 or eyelet 10 to minimize the risk of the hook shank 13 from being pulled out of the body 1 and to also increase the fisherman's line sensitivity.

According to an exemplary embodiment of the present invention, a rattling fishing jig 14 includes a body 1 including an outer envelope 8. A fishing line eyelet 10 is disposed on an upper portion of the body 1. At least one noise-making capsule 3 is disposed in the body. A hook shank 13 includes a first hook. The hook shank 13 is connected to the body 1. The hook shank 13 is in direct contact with the noise-making capsule 3. A stinger attachment eyelet 11 is disposed on a bottom portion of the body 1. A continuous wire 9 is disposed in the body 1. A first end of the continuous wire 9 is connected to the stinger attachment eyelet 11. A second end of the continuous wire 9 opposite the first end is connected to the fishing line eyelet 10.

According to an exemplary embodiment of the present invention, the hook shank 13 may be directly connected to the continuous wire 9.

According to an exemplary embodiment of the present invention, the hook shank 13 may be directly connected to the fishing line eyelet 10.

According to an exemplary embodiment of the present invention, the continuous wire 9 may be a metal wire.

According to an exemplary embodiment of the present invention, the metal wire may include brass or stainless steel.

According to an exemplary embodiment of the present invention, the noise-making capsule 3 may include two capsules.

According to an exemplary embodiment of the present invention, each of the two capsules may be in direct contact with the hook shank 13.

According to an exemplary embodiment of the present invention, the body 1 may include a tail 21 including animal or synthetic hair coupled to the body 1 adjacent the hook shank 13.

According to an exemplary embodiment of the present invention, the continuous wire 9 connecting the stinger attachment eyelet 11 to the fishing line eyelet 10 may have a length configured to create tension between the stinger attachment eyelet 11 and the fishing line eyelet 10. The tension between the stinger attachment eyelet 11 and the fishing line eyelet 10 may be configured to transmit a force applied to the stinger attachment eyelet 11 to a fishing line connected to the fishing line eyelet 10.

According to an exemplary embodiment of the present invention, the noise-making capsule 3 may be in direct contact with the continuous wire 9.

According to an exemplary embodiment of the present invention, a rattling fishing jig 14 includes a body 1 including an outer envelope 8. A fishing line eyelet 10 is coupled to the body 1. At least one noise-making capsule 3 is disposed in the body 1. A hook shank 13 includes a first hook. The hook shank 13 is connected to the body 1. The hook shank 13 is in direct contact with the noise-making capsule 3 disposed in the body 1. A stinger attachment eyelet 11 is coupled to the body 1. A continuous wire 9 is disposed in the body 1. A first end of the continuous wire 9 is connected to the stinger attachment eyelet 11. A second end of the continuous wire 9 opposite the first end is connected to the fishing line eyelet 10. The continuous wire 9 is in direct contact with the noise-making capsule 3 disposed in the body 1.

The above disclosure is intended to be illustrative and not exhaustive. This description will suggest many modifications, variations, and alternatives may be made by ordinary skill in this art without departing from the scope of the invention. Those familiar with the art may recognize other equivalents to the specific embodiments described herein. Accordingly, the scope of the invention is not limited to the foregoing specification. While the present invention has been particularly shown and described with reference to exemplary embodiments thereof, it will be understood by those of ordinary skill in the art that various changes in form and detail may be made therein without departing from the spirit and scope of the present invention.

What is claimed is:

1. A rattling fishing jig, comprising:
a body comprising an outer envelope;
a fishing line eyelet disposed on an upper portion of the body;
at least one noise-making capsule disposed in the body;
a hook shank comprising a first hook, wherein the hook shank is connected to the body, and wherein the hook shank is in direct contact with the noise-making capsule;
a stinger attachment eyelet disposed on a bottom portion of the body; and
a continuous wire disposed in the body, wherein a first end of the continuous wire is connected to the stinger attachment eyelet, and wherein a second end of the continuous wire opposite the first end is connected to the fishing line eyelet.

2. The rattling fishing jig of claim 1, wherein the hook shank is directly connected to the continuous wire.

3. The rattling fishing jig of claim 1, wherein the hook shank is directly connected to the fishing line eyelet.

4. The rattling fishing jig of claim 2, wherein the continuous wire is a metal wire.

5. The rattling fishing jig of claim 4, wherein the metal wire comprises brass or stainless steel.

6. The rattling fishing jig of claim 5, wherein the noise-making capsule includes two capsules.

7. The rattling fishing jig of claim 6, wherein each of the two capsules is in direct contact with the hook shank.

8. The rattling fishing jig of claim 2, wherein the body comprises a tail comprising animal or synthetic hair coupled to the body adjacent the hook shank.

9. The rattling fishing jig of claim 2, wherein the continuous wire connecting the stinger attachment eyelet to the fishing line eyelet has a length configured to create tension between the stinger attachment eyelet and the fishing line eyelet, and wherein the tension between the stinger attachment eyelet and the fishing line eyelet is configured to transmit a force applied to the stinger attachment eyelet to a fishing line connected to the fishing line eyelet.

10. The rattling fishing jig of claim 1, wherein the noise-making capsule is in direct contact with the continuous wire.

11. A rattling fishing jig, comprising:
a body comprising an outer envelope;
a fishing line eyelet coupled to the body;
at least one noise-making capsule disposed in the body;
a hook shank comprising a first hook, wherein the hook shank is connected to the body, and wherein the hook shank is in direct contact with the noise-making capsule disposed in the body;
a stinger attachment eyelet coupled to the body; and
a continuous wire disposed in the body,
wherein a first end of the continuous wire is connected to the stinger attachment eyelet, and wherein a second end of the continuous wire opposite the first end is connected to the fishing line eyelet, and
wherein the continuous wire is in direct contact with the noise-making capsule disposed in the body.

12. The rattling fishing jig of claim 11, wherein the hook shank is directly connected to the continuous wire.

13. The rattling fishing jig of claim 11, wherein the hook shank is directly connected to the fishing line eyelet.

14. The rattling fishing jig of claim 12, wherein the continuous wire is a metal wire.

15. The rattling fishing jig of claim 14, wherein the metal wire comprises brass or stainless steel.

16. The rattling fishing jig of claim 15, wherein the noise-making capsule includes two capsules.

17. The rattling fishing jig of claim 16, wherein each of the two capsules is in direct contact with the hook shank.

18. The rattling fishing jig of claim 17, wherein each of the two capsules is in direct contact with the continuous wire.

19. The rattling fishing jig of claim 2, wherein the body comprises a tail comprising animal or synthetic hair coupled to the body adjacent the hook shank.

20. The rattling fishing jig of claim 2, wherein the continuous wire connecting the stinger attachment eyelet to the fishing line eyelet has a length configured to create tension between the stinger attachment eyelet and the fishing line eyelet, and wherein the tension between the stinger attachment eyelet and the fishing line eyelet is configured to transmit a force applied to the stinger attachment eyelet to a fishing line connected to the fishing line eyelet.
